(19) United States
(12) Patent Application Publication
(10) Pub. No.: US 2009/0020608 A1
(43) Pub. Date: Jan. 22, 2009

(54) UNIVERSAL MEMORY SOCKET AND CARD AND SYSTEM FOR USING THE SAME

(76) Inventors: Jon C. R. Bennett, Sudbury, MA (US); Kevin D. Drucker, Annandale, NJ (US); Stephen Fischer, New York, NY (US); William Githens, Highlands, NJ (US); Michael Kolodchak, Freehold, NJ (US)

Correspondence Address: BRINKS HOFER GILSON & LIONE, P.O. BOX 10395, CHICAGO, IL, 60610, US

(21) Appl. No.: 12/062,287

(22) Filed: Apr. 3, 2008

Related U.S. Application Data
(60) Provisional application No. 60/922,007, filed on Apr. 5, 2007.

(51) Int. Cl. G06K 7/06

(52) U.S. Cl. 235/441

(57) ABSTRACT

A memory circuit card is described, where the electrical and physical interface between the circuit card and a motherboard bus is independent of the memory type installed on the circuit card. The power supply voltage provided by the mother board is independent of the memory type, and persistent and non-persistent memory types may be used on a plurality of circuit cards installed on the motherboard. The power status of at least portions of the interfaces of the circuit card may be controlled at a future time based on signals received at an input of circuit card.

This application claims priority to U.S. provisional application Ser. No. 60/922,007, filed on Apr. 5, 2007, which is incorporated herein by reference.

### TECHNICAL FIELD

This application relates to a socket adapted to accommodate memory modules having more than one type of memory, a memory card, and a memory system incorporating the same.

### BACKGROUND

Computer memory technology has progressed from the use of electromechanical devices such as relays and punched paper tape to magnetic core memories, to magnetic disks, semiconductor memories, optical memories, and the like. This evolutionary transition from one memory type to another has usually required replacing the interface to the host computer, the chassis in which the memory has been housed, and often the computer itself. This has been a problem even when a particular generic type of memory such as dynamic random access memory (DRAM) is used, as newer versions of the memories may have different supply voltage requirements, operation speeds, pin connection arrangements and the like.

The incompatibility of newer memory types with older chassis, bus architectures, memory controllers, or mother boards makes the period of time where a transition in memory technology types is occurring an expensive occurrence, as the availability of the older memory modules may become limited, while the newer memory modules are more expensive. Such older, or legacy, memory modules may continue to have practical utility as the cost of acquisition has long been expensed or depreciated. However, as individual memory modules fail, replacement modules may not be readily available. For some period of time, existing equipment may be cannibalized so that operating memory modules are used to replace the failed memory modules, until such time as the number of spare modules has reached a minimum effective amount, and a complete replacement of the equipment suite, which may include the memory chassis, memory controller, power supplies, and the like, is needed.

### SUMMARY

A memory having a first circuit card and a second circuit card is disclosed. Each circuit card may have a memory circuit; a bus interface circuit having a interface compatible with a bus electrical interface and digital protocol; a memory protocol converter compatible with a memory circuit electrical interface and digital protocol; and, a first voltage converter. The output voltage of the first voltage converter on the first circuit card is different than an output voltage of the first voltage converter on the second circuit card.

In another aspect, a circuit card includes a memory circuit; a bus interface circuit having an interface compatible with a bus electrical interface and command interface protocol; a memory protocol converter compatible with a memory circuit electrical interface and interface command protocol; and a first voltage converter. The output voltage of the voltage converter is less than one half of the input voltage of the voltage converter.

In yet another aspect, a memory system includes a motherboard, having a socket adapted to communicate with a pluggable memory module; a plurality of traces connecting the socket to a memory controller, including at least a power trace. A memory controller may be configured to communicate with a memory module pluggable into the socket. A power supply may be connectable to the power trace. The memory controller discovers a memory type of the memory on the pluggable memory module and the bus electrical interface and power supply voltage are independent of the memory type.

### BRIEF DESCRIPTION OF THE DRAWINGS

FIG. 1 illustrates a memory system having memory modules on a bus;

FIG. 2 illustrates the interfaces of a memory module;

FIG. 3 is a block diagram of a power distribution aspect of a memory system comprising a plurality of memory sub-systems;

FIG. 4. schematically illustrates a memory sub-system having a mixture of memory types and a common bus;

FIG. 5 is a block diagram of a memory module;

FIG. 6 is a functional block diagram of a chip controller;

FIG. 7 is a diagram showing interfaces to a Configurable Switching Element (CSE);

FIG. 8a-f show an arrangement of memory modules incorporating CSEs;

FIG. 9 is a block diagram of a tree-architecture memory system comprising 84 memory modules;

FIG. 10 is an elevation view of a DIMM module configured for DDR2 memory chips;

FIG. 11 is an elevation view of a memory module configured as a universal memory module; and

FIG. 12 is a tabular comparison of the pin functional assignments for a universal memory module of FIG. 11 and a DIMM module of FIG. 10.

### DESCRIPTION

Exemplary embodiments may be better understood with reference to the drawings, but these embodiments are not intended to be of a limiting nature. Like numbered elements in the same or different drawings perform equivalent functions. Elements may be either numbered or designated by acronyms, or both, and the choice between the representation is made merely for clarity, so that an element designated by a numeral, and the same element designated by an acronym or alphanumeric indicator should not be distinguished on that basis.

It will be appreciated that the methods described and the apparatus shown in the figures may be configured or embodied in machine-executable instructions, e.g., in software, or in hardware, or in a combination of both. The instructions can be used to cause a general-purpose computer, a special-purpose processor, such as a DSP or array processor or microprocessor, or the like, that is programmed with the instructions, to perform the operations described. Alternatively, the operations may be performed by specific hardware components that contain hard-wired logic or firmware instructions for performing the operations described, or by any combination of programmed computer components and custom hardware components, which may include analog circuits.

The methods may be provided, at least in part, as a computer program product that may include a machine-readable medium having stored thereon instructions which may be used to program a computer (or other electronic devices) to perform the methods or functions. For the purposes of this specification, the terms “machine-readable medium” shall be taken to include any medium that is capable of storing or encoding instructions or data for execution by a computing machine or special-purpose hardware and that causes the machine or special purpose hardware to perform any one of the methodologies or functions of the present invention. The term “machine-readable medium” shall accordingly be taken to include, but not be limited to, solid-state memories, optical and magnetic disks, magnetic memories, and optical memories, and may include both volatile and non-volatile memory. The description of a method as being performed by a computer may not preclude the same method being performed by a person, in whole or in part.

For example, but not by way of limitation, a machine readable medium may include, at least one of read-only memory (ROM); random access memory (RAM) of all types (e.g., S-RAM, D-RAM, P-RAM (phase change)); programmable read only memory (PROM); electronically-alterable read only memory (EPROM); magnetic random access memory; magnetic disk storage media; flash memory, such as NOR and NAND; magnetic memory, or the like.

Furthermore, it is common in the art to speak of software, in one form or another (e.g., program, procedure, process, application, module, algorithm or logic), as taking an action or causing a result. Such expressions are merely a convenient way of saying that execution of the software by a computer or equivalent device causes the processor of the computer, or an equivalent device, to perform an action or a produce a result, as is well known by persons skilled in the art.

When describing a particular example, the example may include a particular feature, structure, or characteristic, but every example may not necessarily include the particular feature, structure or characteristic. This should not be taken as a suggestion or implication that the features, structure or characteristics of two or more examples should not or could not be combined, except when such a combination is explicitly excluded. When a particular feature, structure, or characteristic is described in connection with an example, a person skilled in the art may give effect to such feature, structure, or characteristic in connection with other examples, whether or not explicitly described. Moreover, the partitioning of functions, in either hardware or software, as shown in the figures, and as described, is exemplary only and is neither intended to suggest that the functions or physical form of component parts shown separately may not be combined, nor that functions shown in a single element may not be performed or embodied separately.

A memory system may be comprised of a chassis or motherboard having a plurality of connectors or sockets; the connectors may communicate with a memory controller over a bus of electrical conductors or other transmission medium, which may be an optical signal, or the like, in or on the motherboard. A optical signal may be transmitted over an optical waveguide, such as an optical fiber, or other dielectric medium. Ancillary equipment such as cooling fans, power supplies and the like, as is known in the art, may also be provided so as to configure an operable memory system. In a connectorized memory system, the memory maymounted to a circuit board having a connector suitable for interface with the connector type provided on the motherboard, and having a signal and power interface to the connector that is compatible with the wiring of the motherboard. The memory board may function, for example, as a DIMM (dual in-line memory module), a FB-DIMM (fully buffered DIMM), a flash memory stick, a CSE (configurable switching element) with RAM or semiconductor memory, or the like. A CSE is a type of bus and memory interface which has been described in U.S. application Ser. No. 11/405,083, entitled “Interconnection System”, filed on Apr. 17, 2006, which is commonly assigned, and is incorporated herein by reference.

The form factor of the memory board may be selected based on the product development requirements. In an aspect, at least one of the form factor or the connector type used may be that of a standard DIMM module, however as the pin-outs may be different, the connector may be keyed so as to prevent modules other than the present memory arrangement from being inserted in the socket. Alternatively, the pin-outs and interfaces of the memory board may be selected so that plugging the memory module into an existing motherboard having a compatible connector does not result in damage to either the motherboard of the module, although proper operation may not always be possible.

Operation speed, power consumption and physical and storage size are parameters characterizing memory systems that are undergoing continuing improvement. The changes may be incremental and generational. As the speed with which data is transmitted between a memory controller (MC) and a memory module (MM) is increased, the electrical bus architecture has tended towards a differential pair of lines rather than an unbalanced configuration. Concomitant with this change, the data transmitted on the differential pair of conductors may be configured in a bit-serial manner so that the total number of differential lines can be reduced. This may be compared with the unipolar approach where a plurality of lines may be used and, for example, each line may carry a single bit of a data or command word. Serial data transmission has also been adopted so as to reduce the number of individual data lines that need to be interfaced with the connector. As the data density of memory modules increases, the number of individual connections required for a parallel interface may create spacing problems in the physical connector, and in the electronic cross-coupling of signals. Where optical signals are used for data transmission, a typical mode of data transmission is bit-serial between an optical transmitter and an optical receiver. In another aspect, optical frequency-division multiplexing may be used.

Nothing herein is intended to limit the scope to a particular bus architecture, and serial, parallel, differential and single-ended bus structures may be used, including a stub bus, a multi-drop bus, a ring bus a tree bus, or the like.

In an example, a serial data stream transmitted over a differential bus may be received by a device on the memory module which provides an interface between the bus signals and the memory chips, which may be mass produced memory chips. These may be so-called “commodity chips.” The data transmission speeds at which a differential data line in a serial bus may be operated may substantially exceed the data rate of a parallel bus. With appropriate de-multiplexing and processing of data received on the bus, a variety of memory types may be used. The memory operating speeds may be slower than, equal to, or greater than that of the bus on the mother board.

Generally, when the term data is used, it is meant in a broad sense, so as to include information, control signals, status signals and the like, which may be needed by a memory for operation in a memory module. The address decoding for interfacing with the bus may be performed on the memory module, or by circuitry having the same effect and mounted on the mother board or backplane. When the interface is partly on the motherboard, the bus interface on the motherboard has an interface characteristic compatible with the remaining portion of the interface on the memory module.

A bus interface or a memory interface may be characterized as having a configuration or protocol having physical, electrical and digital characteristics. As examples, but not by way of limitation, by physical, the size of the device, arrangement of connector pins and the like is meant; by electrical, the voltages, currents, impedances, signaling levels and clock speed is meant; and, by digital, the interpretation of electrical signal levels as logical representations of control functions and data values is meant.

Although the operating voltages for a memory chip are often standardized for a particular generation of technology, multiple voltages may be needed, and the use of different technologies such as FLASH and DRAM may require a variety of voltages. This plurality of voltages may not be available on a motherboard intended for a single type of memory chip, and the lack of such voltages may preclude using a mixture of memory types on pluggable modules.

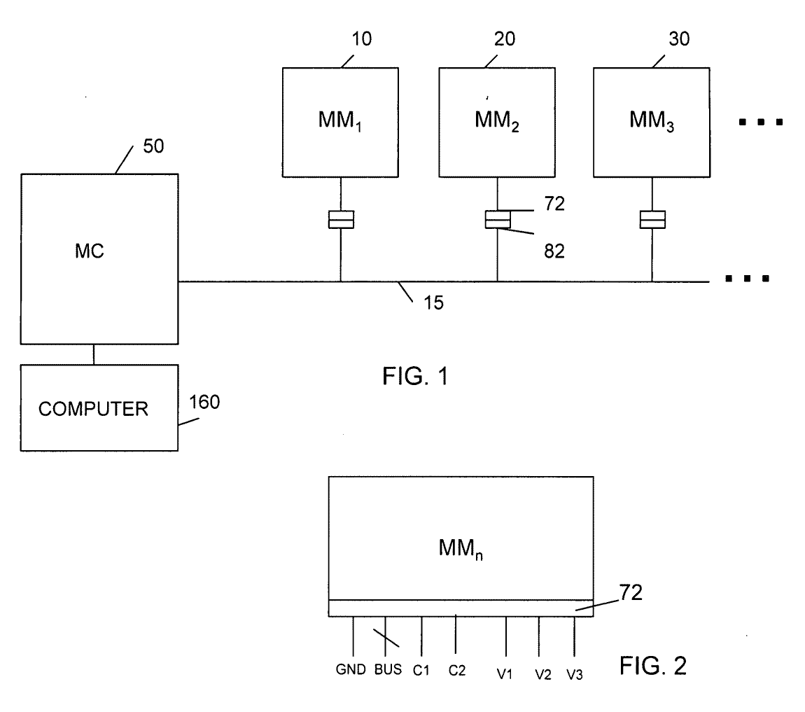

FIG. 1 shows a memory system 1 comprised of a computer 60, a memory controller 50 interfaced to the computer 60, and having at least one data bus 15 to which one or more memory modules 10, 20, 30 may be attached through connector sockets 82. Not shown are ancillary equipment items such as, for example, cooling fans, or the power supply to supply the operating voltages for the various components. FIG. 2 is an interface diagram for a typical memory module MM. This module may be constructed using a variety of components having differing characteristics from module-to-module. However, the module interface at the connector socket 82 may be standardized as to form factor, pin-out, voltages and the like. Here, the edge connector 72 of the memory module MM, which may mate with the socket 82 on the motherboard, may have the same pin out for all of the modules. In this example, the pins may be assigned to ground (GND), to the bus 15, to control signals C1, C2, and to voltage supply lines V1, V2, V3. That is, each specific pin performs the same function, if needed, for each of the memory modules, without regard to the specific memory type or capacity of the memory module.

Other arrangements are possible, and the number of each type of line, or other aspect of the interface protocol, is not limited by this description, which is given merely as an example of a design. In particular, the bus may have multiple differential pairs, may be single ended, may have a single port or an input port and an output port, or multiple input and output ports, and some of the functions of the control signals may be assignable by either hardware or software.

The module may operate on a first voltage V1, and may use one or more secondary voltages V2, V3, and the secondary voltages may be determined by the technology of the memory chips and other chips installable on the board. Alternatively, the secondary voltages V2, V3 may be generated by converting the first voltage V1 to the secondary voltages. The choice of a common power supply for V1 and either a common power supply or individual conversions from the primary voltage to the secondary voltages may be done on the basis of economic or other design considerations.

In an aspect, a single power supply may be used for V1, and the modules pluggable into sockets on the motherboard or a section thereof may be provided with the supply voltage from the power supply, which may be either mounted to the mother board or installed separately. When the power supply is separate from the mother board, the power supply may not be located close to the mother board, or may not be in the same rack.

The design of large memory systems may have power efficiency as an important design consideration, and the overall efficiency of the power conversion between generated power from the electrical grid and the direct current power needed for the memory system is desirably as high as possible, subject to other design constraints, including economics. Power supplies may operate more efficiently if the load current is both a high proportion of the power supply capacity, and relatively constant. Such a condition may be more easily achieved when the power supply is common to a large number of memory modules.

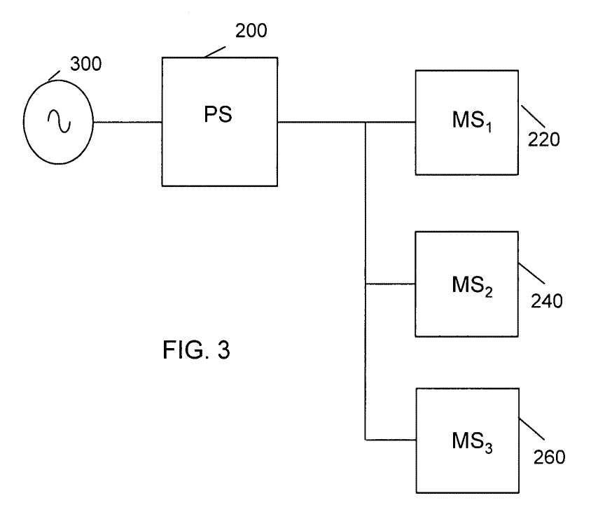

FIG. 3 illustrates an arrangement where a power supply 200, serves to convert prime power 300 (usually an AC voltage from a power grid, but the power input can be from a local electrical generator, or the like) into a DC voltage suitable for further use in the system. Such a power supply 200 may have additional attributes such as being a redundant power supply, or an uninterruptible power supply (UPS), where batteries are charged when prime power 300 is available, and used to maintain continuity of power supply during outages in the prime power supply. The UPS may supply DC power in place of the power supply 200 during the power interruption, or be re-converted to an AC voltage. The power supply 200 may be a single power supply for a plurality of memory systems 220, 240 260, or be associated with an individual memory system, or mother board thereof. In an aspect, the power supply 200 may provide power at voltage V1, or at a higher or lower voltage, which may be converted to voltage V1 on the mother board or a portion thereof, the memory module or the like.

Initially, the prime power 300 may be converted to a relatively high DC voltage, such as 48 VDC, rather than a typical 12VDC or 5VDC as would be used in semiconductor-based equipment. Higher voltages may be used for a stage of power distribution as the resistive losses are lower for a given power transmission. This arises from the lower I²R power loss in conductors since the power is P=VI, and the higher the voltage, the lower the current for a fixed power consumption. The initial voltage may be higher or lower than 48 VDC; however, voltages higher than about 48 VDC are considered hazardous to personnel and may involve special safety precautions. However, the use of such high voltages may be desirable when high capacity systems, or large distances between the power supply and the memory, are contemplated.

Semiconductor devices usually operate on 5VDC or lower voltages, and therefore the 48 VDC has to be converted to this lower voltage. The voltage conversion may be made, for example, by a voltage converter associated with the mother board, or with a voltage converter located on the memory module 70. In addition to producing the first voltage V1, secondary voltages may be produced in a similar manner from the first voltage which may be, for example, 12 VDC. The first voltage, V1 may be higher than any of the voltages used by other than a power converter on the MM, and may be, for example, 48 VDC. The higher the voltage value of V1, the less power loss encountered in distribution of the power on the mother board to the individual modules. In an aspect, the power may be distributed at 12 VDC on a motherboard, and converted to, for example, 5 VDC, 3.3 VDC or 1.8 VDC, or some other voltage, at each module as needed for the particular electronic technology being used.

In another aspect, as shown in FIG. 2, the module may have one or a plurality of voltages being supplied from the motherboard, and these voltages may be selected based on a presently used memory technology. However, the overall capacity of the power connections may be sized such that the power needed by the module may be transmitted through the contacts of socket or connector. Thus, modules that require voltages differing from V1, V2 or V3, which may be the voltages that may be available on the motherboard may have the voltages generated at or on the memory module MM from one or more of the original voltages. All of the power may be derived from a single voltage V1 on the motherboard. However, other voltages which may have lower power requirements may be effectively supplied from V2, and V3.

In an aspect, one or more of the voltages V2, V3 may be generated by a power conversion module in the memory system which may be replaceable, and may be connectorized. In this aspect, once the need for a voltage in the system has been obviated by a technological change, the power module associated with the voltage may be removed and replaced by the required voltage, or to supply power at one of the other voltages. Such power supplies may be configured to serve only a portion of a motherboard, so that when groups of memory modules are changed to a different technology, the appropriate power supply may be installed.

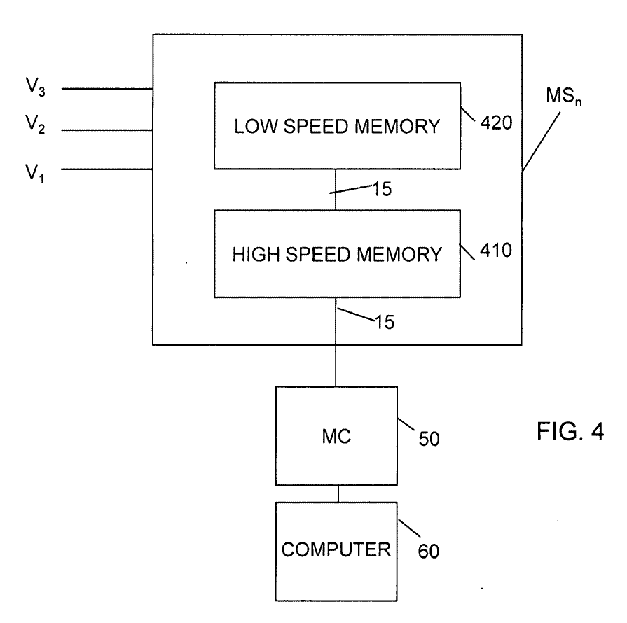

In another aspect, a mother board may be populated with modules MM having differing memory chip technologies. For example, FIG. 4 illustrates a memory system MS having a mixture of memory types, for example, DRAM and FLASH, at least some of the memory circuits being part of connectorized memory modules (MM) 70 pluggable into sockets 82 so as to communicate with a bus 15. The memory types may be, for example, a high-speed memory 410 and a lower-speed memory 420 or, in general, memory types having differing attributes.

For example, the high-speed memory 410 may be one or more DRAM chips or other memory types which are being or may later be developed, which may have the attributes of high read and write speeds, ability to write and read a substantially infinite number of times, and being of a non-persistent type. That is, the data would be lost if the power is interrupted. This type of memory may be used, for example, for computer main memory, or cache memory, to store program code for execution, and data that is frequently used.

The lower speed memory 420 may be FLASH memory such as one or more NOR, or NAND memory circuits, or memory types which are being developed, or may be later developed. Such memories may be characterized as having an operating lifetime that may be measured in the number of read or write cycles to a given memory location, a slower read or write speed than the high speed memory, and may be of a persistent memory type. That is, the stored information is retained when power has been interrupted.

Memory-type attributes have been described merely to indicate that the memories may have differing characteristics, and that it may be desirable to use more than one memory type in a memory system MS; however, the specific characteristics of the memories described is not intended to be a limitation on the use of any memory type that is presently known or may be developed, in this memory system. That is, the memory system MS may include memory modules MM of differing characteristics, and the memories may be used for different purposes, while residing on a motherboard and connecting through a memory controller.

A plurality of memory types may be used on a motherboard, and connected using a common bus type, such that the data on the non-persistent memory may be transferred to, or backed up in, the persistent memory. This capability may be used on a routine basis, in the case of power failure, or for the physical transport of a data base, or similar purpose.

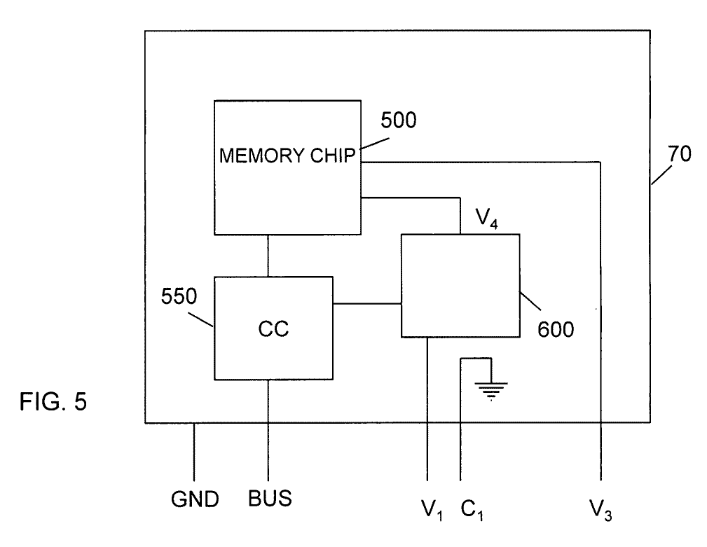

Concomitant with the differing memory performance characteristics, the memory chips may have, for example, differing interface protocols, clock speeds, and operating voltage requirements. FIG. 5 shows a block diagram of a memory module 70 having a memory chip 500, which may be a plurality of memory chips, a controller 550 and a power converter 600. In this example, the power supply voltage V1 is used to supply power to the memory 500 and to a power converter 600. The power converter 600 may convert the voltage V1 into a voltage V4 that may be needed by the chip controller 550, but may not available through a connection to the mother board. Another needed voltage, V3, is presumed to be available from the mother board in this example. Voltage V2 may be available from the motherboard through the socket, but may not be used by a module with a memory type that does not operate on a voltage V2 and, unless the voltage V2 is to be converted into another voltage on the module, a connection to V2 may not be made in the module wiring, although the voltage may be available at the designated pin on the connector.

The use of a single voltage source, V1, for all or substantially all of the power requirements of the memory module may increase the design flexibility with respect to future circuitry generations.

A control signal C1, in this example a ground, may be used to identify the type of chip 500 being used so that the controller may adapt to the memory configuration. However, alternative means may be used at system start up or when a module is replaced, including polling the chip controllers 550.

The chip controller 550 provides an interface between the memory chip 500 and the data bus or to a bus interface located on the motherboard, where the same type of data bus 15 is used by the memory modules MM, but the memory chips 500 may differ in technology, required voltage and power, data storage capacity and access speed. The chip controller 550 may accept commands or data from the memory controller or other source over the bus 15 and may convertor translate the commands or data into one or more of the form, format, or timing needed by the memory chips of the memory module MM. When data or status is output from the memory chips 500, the chip controller 550 accepts such data and may convert or translate the commands from the form, format, or timing of the memory chips into that of the bus 15. This function may be generically termed protocol conversion, and may be a null conversion for some memory chip types. The bus protocol is common to all, or a group of, the sockets, and the chip controller 550 provides the conversion of the protocol to that required by technology or specific design of the memory chip being used on the memory module. The memory chip 500 may represent a plurality of memory chips which may be arranged on a separate local bus on the circuit card. The local bus may have a different protocol from the system bus on the motherboard.

Depending on the memory chip type, the set of commands that may be executable by the memory chip 500, and the response to a command, may be different from memory-chip-type-to-memory-chip-type. A number of techniques for identifying the memory configurations of a memory module are known. In an aspect, the control lines C1, C2 may be used. The memory controller 70 may poll the control lines to determine the characteristics of the memory chip 500. Characteristics of the control lines, for example a ground or a high, may be sufficient in some embodiments. Alternatively, a more elaborate protocol may be used.

In an aspect, each chip controller 550 may be a microprocessor programmed using a stored or loadable software program, or specifically designed (such as a application specific integrated circuit (ASIC) or other electronic circuit) to account for the characteristics and attributes of the memory chip 500 with which it interfaces, so as to be able to communicate with the memory chip 500. Thus, the characteristics of the memory chip 500 are known to the chip controller 550. As has been described, each chip controller 550 is compatible with the interface and protocol requirements of the bus 15 and the memory controller 50 to which the chip controller 550 is interfaced through the bus 15, or to a secondary adapter located on the motherboard and associated with one or more sockets. Hence, at power on, or any other time that the function needs to be performed, the memory modules MM on the bus 15 may be selectively addressed by the memory controller 50

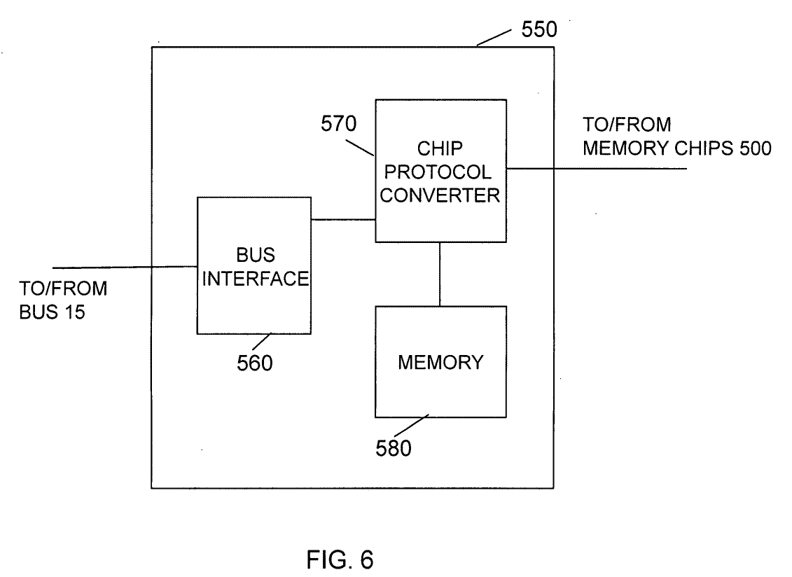

FIG. 6 is a block diagram of an example of a chip controller 550. The chip controller may have a bus interface 560, a chip protocol converter 570 and may also have a memory 580 which may be a persistent memory, a non-persistent memory or a combination of the two memory types. The bus interface 560 may provide the protocol interface with the bus 15 that connects the memory modules 10, 20, 30 to the memory controller 50. The physical and electrical interface between the bus interface 560 and the bus 15 may be the same for all, or a group of, memory modules, without regard to the actual memory technology or specific characteristics of the memory chip 500. As such, commands and data are received from, and status and data are transmitted to, the memory controller 50 in a format that may be independent of the memory chip technology. A generalized command set and data representation may be adopted for design purposes, or a specific command set and data representation associated with a memory type may be used. The chip protocol converter 570 may be a hardware and software interface between the command instruction set and hardware characteristics of the bus interface 560 and the specific memory type of the memory chip 500 which is used on the memory module MM. The details of the chip protocol converter 570 may therefore be different on the memory-chip-side of the converter, but have the same characteristics on the bus-interface-side of the converter.

A data element of the command set may be a request for device type, and a response data element may be used to identify the device type of the memory and size of the memory on the addressed memory module MM. Thus, periodically, or as part of a power-on sequence, for example, the memory controller 50 may determine the type of memory chip associated with a memory module MM at a specific address or address range on the bus 15. Associated with a determination of the memory chip type is a definition of the specified attributes of a memory module having the particular chip part installed. That is, depending on the chip technology and the specific design of the chip being used, the commands that a chip may respond to, the data format, the timing of the actions, and reporting such information as status, and the like, may differ. Having identified the specific attributes of the individual memory module, the memory controller 50 may determine the type of data to be stored in a particular memory module, the command set to be used, and the like. The details of such attributes may be stored in the memory controller 50, the host computer 60, or other memory, and may be updated when new memory types are introduced. Updating of the software of a device having instructions stored in computer-readable memory is known in the art, and will not be described further herein.

In an aspect, the bus interface 560 may be a configurable switching element (CSE). The CSE may be disposed on a memory module MM.

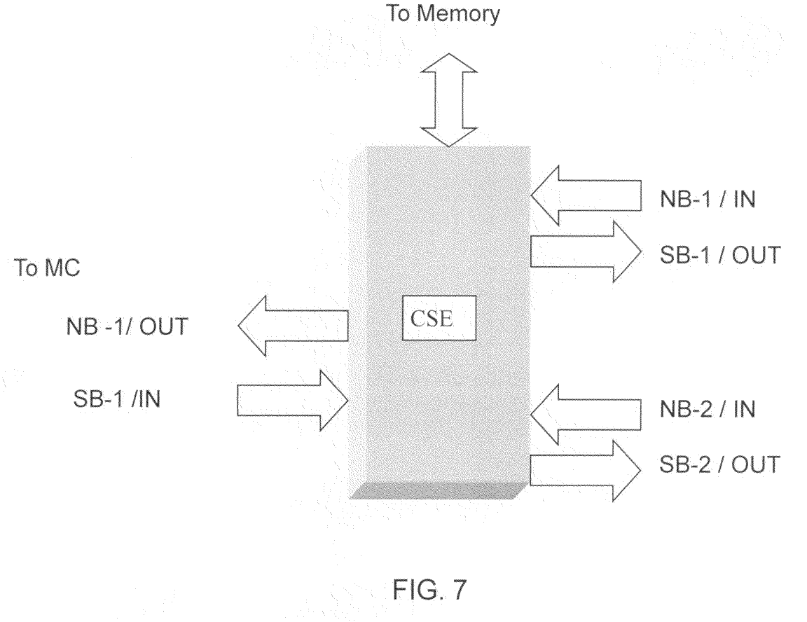

FIG. 7 shows an example of a Configurable Switching Element 15 (CSE), which may have more than one secondary, or downstream, port, such as may be used in a binary tree of memory modules. In an alternative the CSE may have one secondary port, or a plurality of secondary ports, depending on the specific system design.

The CSE may be used to communicate with memory or other devices; the memory or other devices may be located on the same physical module as the CSE or may be located on a separate module from the CSE, on the mother board, or at another location. In this figure a double-headed arrow associated with an interface indicates a bi-directional data path, which may be separate uni-directional links, or bidirectional links, or may be logically bi-directional connections made by running uni-directional links in a ring-like fashion. Links may have a serial or parallel configuration, or be a combination of series and parallel configurations and be either single ended or differential. A plurality of uni-directional links may be used to form a bi-directional data path. The interfaces to a CSE may be called “ports”.

The CSE may have the capability to connect any input port to any output port. For convenience in logical description, the ports associated with the system bus may be considered northbound or southbound in the present description, however such a description does not serve to limit the capability of the ports of a CSE to communicate to each other. For, example a northbound port may communicate with a southbound port within a CSE, or a southbound port may operate as a northbound port in a multi-rooted tree connection. A port may also communicate with another device such as a memory, where the port has been adapted to have a compatible protocol. Of course, not all of these capabilities may be configured in a particular arrangement.

The CSE may have various internal processing functions (or such functions incorporated inside the CSE and operate in conjunction with devices having various processing functions) such as, microprocessors, or direct-memory access (DMA) engines, the CSE itself being a module controller for controlling other CSEs, and the CSE may be externally connected to devices other than the memory system such as input/output (I/O) devices, microprocessors, graphics processors, co-processors, other CSEs, etc. The use of the terms “primary” and “secondary”, “northbound” and southbound”, and “upstream” and “downstream” are thus seen to be used for convenience in description. In the situation where a CSE contains a microprocessor (or is contained within, or coupled to, a microprocessor), the CSE may act as a processing unit as well as a switch.

The signaling convention for a read command and response utilized herein is conceptual in order to simplify the functional description. For example, a “read” command may take several messages, which have been compressed for discussion herein into one message.

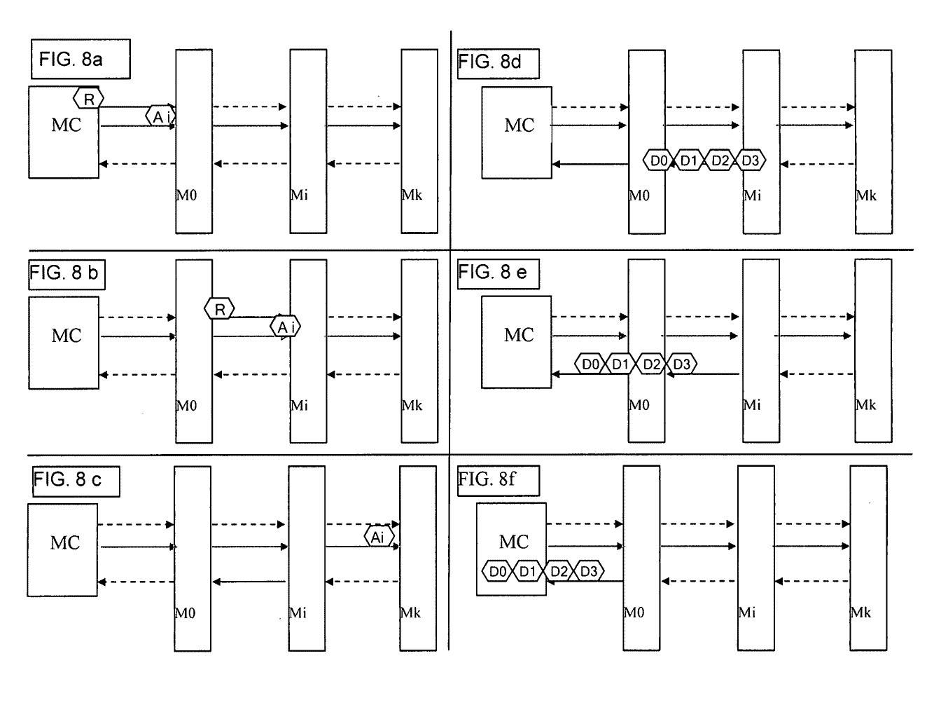

In FIG. 8a, a read command is issued by the memory controller as an address Ai and a read command R and transmitted over the downstream path as a “packet”. With other than a CSE, the packet would be repeated promptly from one module to another down the linear chain, so as to minimize the affect on latency. Thus, even though the read command was addressed to memory module mi, as shown in FIG. 8c, the packet would have been further forwarded to memory module mk. Therefore, each of the packets containing the read command would traverse the full length of a chain of memory modules MC. The data and control lines are active in both upstream and downstream directions.

However, each CSE may be in a state where the upstream paths are in a “reduced” power setting, shown as a dashed line in FIG. 8. Reduced power may include but is not limited to, de-powering the I/O drivers, gating the clock of the I/O logic (and any other associated logic that can be stopped), reducing the clock rate of the I/O logic, reducing the voltage of the I/O logic, loading preset inputs to the I/O logic that are designed to reduce the leakage current of the I/O logic, or any other method of for reducing the power consumed by any portion of the chip, including any associated on-module memory, which may be undone quickly enough to enable the handling of the returned data. In the example shown in FIGS. 8d-8f, the upstream links may power up in advance of the returning data and then return to a reduced power state after the data passes.

In this example, the control signals travel as a packet over the data lines where the downstream path is powered up. In an aspect, where the packets are transmitted in a “framed” or “slotted” timing system, the downstream path may be powered up at the beginning of each “frame” or “slot” time and if there is a packet to be sent the transmit side may remain powered up and the packet sent; otherwise the transmit side may be powered down until the beginning of the next slot time, and the receive side will be powered up until a determination is made as to whether a packet to be received; if there is no packet, the receive side may power down until the start of the next slot time.

FIGS. 8a-8-f depict a configuration of memory modules M employing CSEs having separate command and data lines between modules. The signal and command lines may be merely a subset of the data lines rather than dedicated signal lines. In the configuration shown, some portion of the downstream links and their associated logic may be in a reduced power state. As the command control signal passes each module the signal is decoded and, if appropriate, other downstream links may be powered up to transmit the data or command which follows in a data packet. In the aspect shown, a read command R is issued for an address Ai in memory module Mi, where read command R and the address data Ai are sent on separate lines. The address data Ai indicates that the desired address or address range is in memory module Mi. As the address data packet Ai may be transmitted earlier than the read command R, the address data packet Ai at each of the memory modules M# earlier than the read command R, as may be seen in FIG. 8a-b, and the address data may be used to power up the link between the receiving module Mi+1 and the transmitting module Mi so as to accommodate the transmission and processing of an expected command. The downstream command path may be powered down again after the command has been received, the upstream links may be timely activated for the transmission of the data read as a result of the command. FIG. 8a illustrates a situation where a MC issues a read command R for an address Ai. In FIG. 8b, the read command R data packet arrives at memory module Mi, for which it is intended, and is not passed through to memory module Mk (FIG. 8c). As a result of the data read command R, a packet of data D0-D3 is transmitted upstream (FIG. 8d), passing from memory module Mi (FIG. 8e) and being received by the memory controller MC (FIG. 8f). In the sequence shown in FIGS. 8 c-f, the powering up of each successive upstream link prior to transmitting the read data over the link is illustrated, as well as the powering down of each link after the passage of the read data D0-D3.

As the data read command R packet passes along the downstream path from M0 to Mi and to Mk, each of the memory modules M may observe or “snoop” the data read packet and ascertain both the destination module and the specific nature of the command: in this example, to read data from an address in Mk. Such read data traffic is expected to flow upstream from Mk to the MC. Consequently, each of the links in the upstream path between the module from which the data will be read and the MC may be powered on at an appropriate future time (shown as a transition from a dashed line to a solid line) to transmit the read data, and may be returned to a low power state or turned off when the read data has been transmitted over the link. The upstream links for the path between the addressed memory module (e.g. Mi) and the MC may be powered on at appropriate future times, resulting in a reduction of power consumption.

Thus, the power status of one line or lane may be said to be alterable at a future time, based on the control or command signal, address or data signal being received by a CSE. The time value of a future time status change may be determined by a characteristic of the received command, the address of the destination, the corresponding position of the receiving CSE in the network, or similar or derived information, or may be intended to occur promptly for some or all of the lines or lanes of a CSE.

Where a module such as the CSE is used as an interface between the memory on a memory module and a data bus, the speed of information transmission on the data bus may be independent of the memory type, and the response time of the memory type, and both “fast” and “slow” memory may be used on separate modules, or in the same module. A buffer memory on the module, which may be associated with the CSE, for example, may be used so as to buffer the input data and requests, and to buffer the responses so as to achieve compatibility with the overall system timing.

Since the power consumption characteristics of the CSE and the associated memory may be managed so that the electronic components may be placed in a lower power state when there is no anticipated use, and energized when there is a need for, for example, receiving or transmitting information, the overall power consumption of a memory module may be reduced.

In another aspect, the mother board and the memory controller may adapt to the use of new types of memory, and a change in the specific type of memory associated with the memory module inserted into the motherboard socket at a specific location. This capability also permits the amount of memory of various types to be changed in a memory system. That is, a mix of, for example, a particular type of DRAM and a particular type of FLASN may be desired but, at some juncture, the number of memory modules of each type may need to be changed. The memory controller 50 may be programmed to be capable of identifying the type of memory, and the address range of each memory module and to associate the memory type with a location on the bus 15.

The bus architecture may permit hot swapping of modules. That is, a failed module, or a module to be upgraded or the like, may be replaced with a another module while the remainder of the system remains operable, and the exchange may be performed without loss of data. Data loss may be prevented, as is known to persons of skill in the art, by using any of a variety of error correction or redundancy techniques, such as RAID (Reliable Array of Independent Disks). A failed memory module may have been identified by the error checking capabilities associated with the memory module, by error checking capabilities associated with the operation of the memory controller, or the like. The failure may also be characterized by a lack of response to a command sent from the memory controller to the memory module.

A failed memory module may have been identified to the person maintaining the memory system by means of a display, or a print out, which may be displayed locally, or be transmitted over a network such as a LAN, a WAN, or the Internet. A failed memory module may also be identified by an indicator light thereon, the light being controlled either by the module itself or by another portion of the memory system.

The memory module may be replaced at a time convenient to the operator of the system, and the time necessary to replace the module may be considered a long time as compared with, for example, the time scale of a memory read request and response. Hot swapping of a device may be facilitated by connectors where the ground pin is longer than the other pins, and the power pins are shorter than the ground pin, but longer than the data pins. Alternatively, the configuration of power pins may be such that the connector is properly insertable prior to the application of power, or the pins arranged so that the application of power is sequenced. In this manner, the ground connection may be broken last when the memory module is unplugged, and the ground connection is made first when a new memory module is plugged into the connector. Similarly, the lengths of the other pins may manage the time sequence of making or breaking connections, so that the device is in a known state when connecting to and disconnecting from the bus.

When a memory module is replaced, the memory module may transition form an un-powered state to a powered state as it is plugged into the bus. Depending on the design, the memory may remain in a powered quiescent state until a specific command is received over the bus, or the memory module may initiate a response to the power-on sequence of operations. Depending on the system design, the memory controller may then poll the modules to ascertain the configuration change. The memory controller may maintain a data base of the sockets having installed memory modules, and respond to the status message by also polling the sockets that were unpopulated or marked as defective.

In an aspect, the memory controller may periodically poll all of the known module locations to verify proper operation of the memory modules, and in the process thereof discover the replaced module as being operational. Alternatively, for example, the memory controller may periodically poll the memory locations of failed memory modules so as to determine if the module has been replaced with a working module, and that the memory module is again available for data storage.

In addition to the type of memory used in a particular memory module, other information relating to the specific condition of the memory module may be stored in local memory 580. For example, usage data for data blocks in a flash memory chip may be retained in a persistent memory on the memory module. The persistent memory may be a portion of the FLASH memory chip or be a separate memory chip. Since a specific memory module may be unplugged from a connector at a first bus location and moved to a connector a second bus location, the wear status of the memory module, for example, may be lost if the wear status is not stored in some memory that may be associated with the specific memory module. Individual memory modules also may be serialized or store other data so that a memory controller may determine that the physical location of a memory module on a bus has changed, and that the wear or other status of the specific memory module should be retrieved for use by the memory controller. This wear status may also include, for example, the identification of bad blocks.

The chip protocol converter 570 may convert both hardware and software protocols so that the commands and data on the bus are usable by the specific memory chip 500 on the memory module. The protocol conversion may also include buffering the input or output data so that the data may be sent on a bus where the operating speed is either greater than or less than the operating speed of the memory chip. Commands may be reformatted so as to be usable to the memory chip, and commands that may not be executable may create report of a command error. The memory controller 50 ordinarily may send data and commands of a type compatible either with the bus interface, or convertible by the chip protocol converter so as to be compatible with the memory chip.

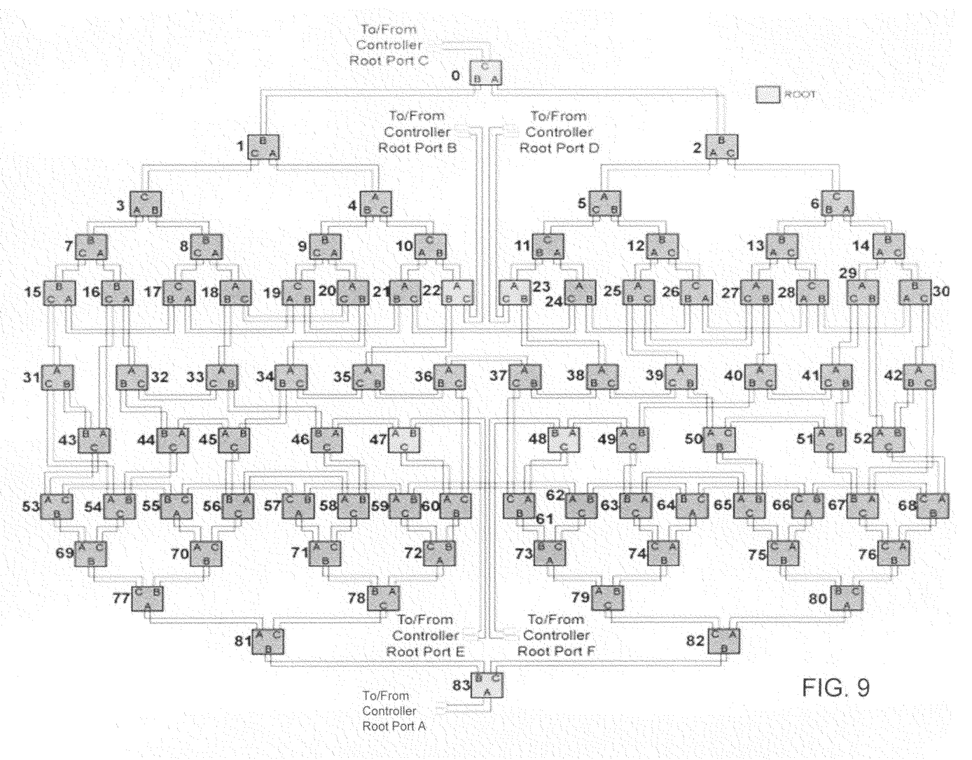

In another example, a tree-like bus, such as shown in FIG. 9 may be used. A tree memory architecture has been disclosed in U.S. application Ser. No. 11/405,083, entitled “Interconnection System”, filed on Apr. 17, 2006, which is commonly assigned, and is been incorporated herein by reference. In this example, 84 memory modules are organized as a multi-rooted tree, where 4 roots are connectable to computer-interfaced memory controllers. Each of the modules is connectable to three other modules, one of which may be a memory controller. An aspect of this architecture is that the failure of any one of the modules may not result in the loss of connectivity between the computing system and any of the other memory modules. Alternative data paths exist, and if a redundancy technique such as RAID is used, the data in the defective module may be reconstructed and stored in another module.

Thus, a memory module may be removed, without causing a loss of data. This architecture facilitates hot-swapping of memory modules so that a failed module may be replaced, or a module having a differing memory type may be installed without interrupting the operation of the memory system. That is, a memory module may be unplugged from the motherboard while the remainder of the memory modules plugged in to the motherboard are powered up and functioning as memory modules. A memory module may be plugged in to a connector on the motherboard, without the disabling the power or access to the remaining memory modules plugged into the mother board. Power for the module being plugged in may be present while the module is being plugged in, or be enabled by the plugging in of the module.

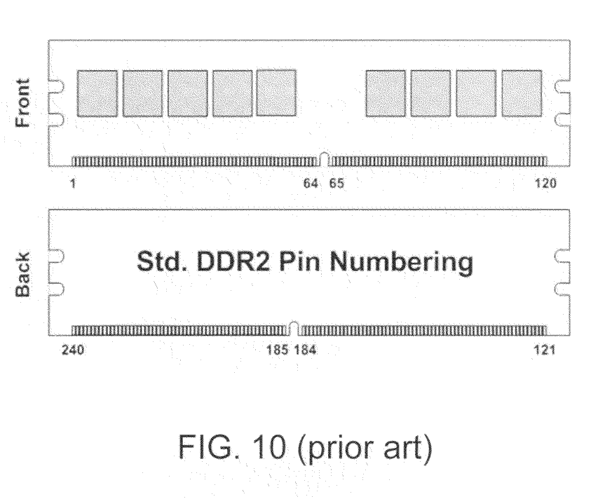

Evolutionary changes in memory systems occur, and it may be desirable to be able to use existing connector types during such a transition period, at least. The pin out of the memory modules described herein may be designed to be compatible with an existing connector, such as the 240-pin DIMM connector now being used in DDR2 memory systems and conforming to JEDEC MO-237. FIG. 10 shows an elevation view of the connector, having a key positioned between pins 64 and 65 on the front side, which corresponds to being positioned between pins 184 and 185 on the back side. The position of the key is such that that the connector can only be plugged into the socket in one orientation. A memory card, which may be plugged into a conventional DIMM socket, therefore has a key slot the position shown in FIG. 10.

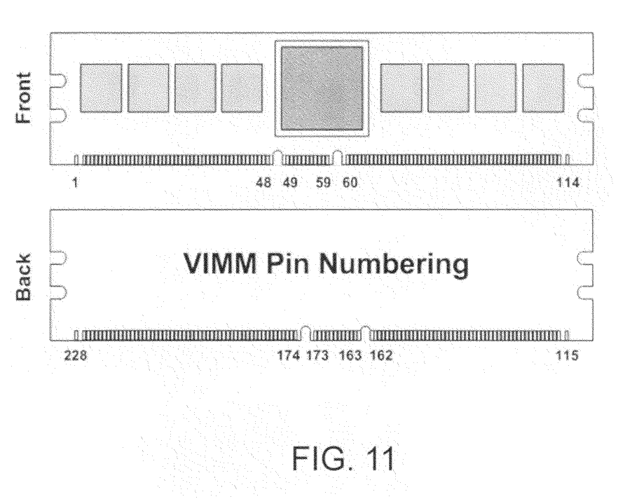

An example of a universal memory card is shown in FIG. 11. The form factor of the card shown in FIG. 11 is the same as that in FIG. 10, having a key slot positioned in the same place, but is also shown as having a second key position. The first key position is shown as being located between pins 59 and 60 on the front side and pins 162 and 163 on the back side as for a standard DDR2 memory module. A comparison of FIGS. 10 and 11 indicates that the physical location of the first key slot is the same, and the different location designation arises from the numbering of the pins. The second key position is located between pins 48 and 49 on the front side, corresponding to pins 173 and 174 on the back side. The second key slot has no counterpart in the standard DDR2 DIMM connector and circuit board. The universal memory card is shown having the same elevation dimension as a DDR2 DIMM module, however, this is not a limitation, and the card may have either a greater or lower elevation height.

In a situation where the standard DIMM connector is being used, both a standard DIMM DDR2 memory card and the universal memory card may be plugged into the same socket. In this situation, the voltages appearing on the pins of the socket are preferably compatible with the capabilities of the electronic components on the cards that may be plugged in, in order to avoid damage to the card or to the motherboard and power supplies. In particular, the universal memory card and socket may be designed so that the application of standard DIMM memory voltages and loads will not damage the card. The socket and motherboard may be designed so that the application of voltages and loads associated with the universal memory module to a DIMM DDR2 memory module will not damage the DIMM DDR2 memory module.

Where the motherboard is designed for use with the universal memory card, and standard keying DIMM connectors are used, a DIMM module should be capable of being plugged into the universal memory motherboard without permanent damage to the DIMM module or the motherboard.

When a second of the module key positions is used in the connector, and has a corresponding key slot in the memory module, as shown in FIG. 11, the DIMM DDR2 memory module is no longer pluggable into the universal memory motherboard. Such a situation may arise at a later date when the transition between DIMM memory modules and universal memory modules has progressed further. When DIMM modules are no longer pluggable into universal memory motherboards, additional functionality may be added using pins which may have been incompatible with the DDR2 voltages and loads.

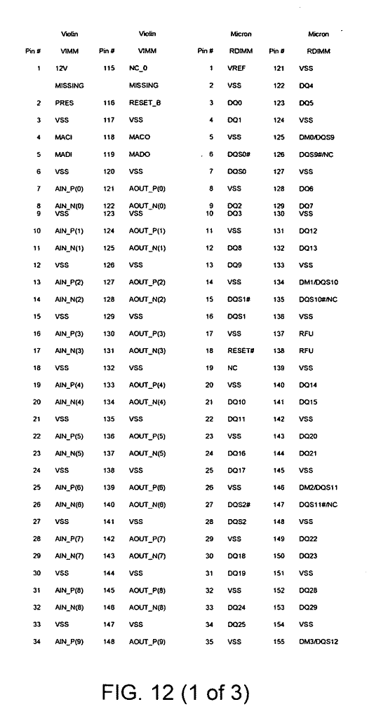

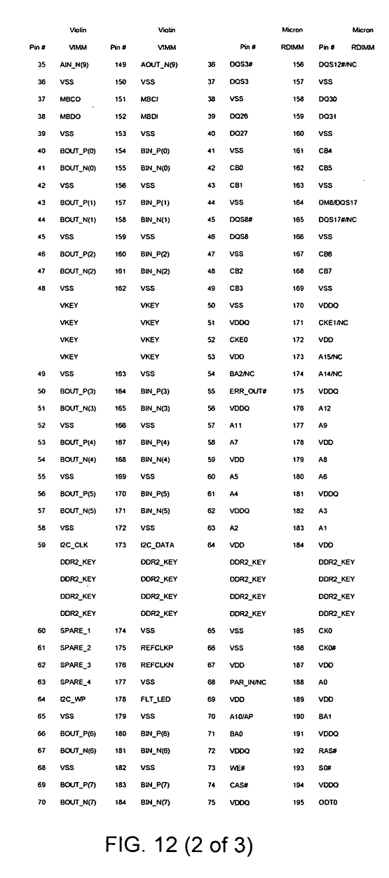

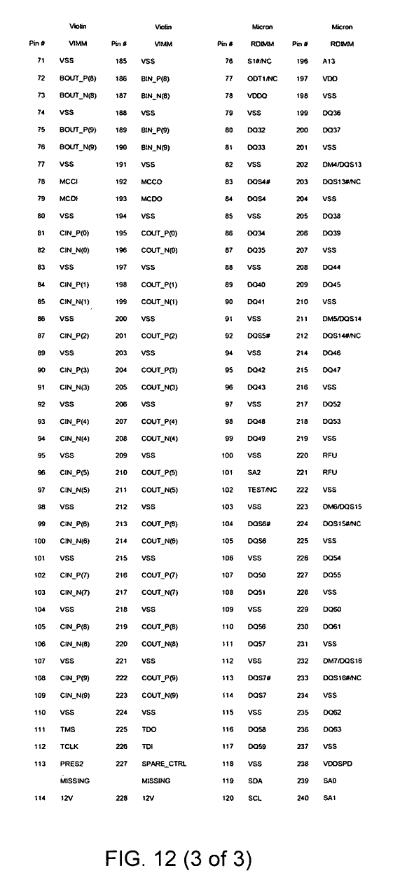

FIG. 12 illustrates an example of a pin out of a universal memory module socket. The pin out of an example of the universal memory module is shown in the left-hand pair of columns, and the pin out of a DDR DIMM memory module socket is shown in the right-hand side pair of columns. The tabular arrangement of FIG. 12 orients the physical location of the corresponding pins on the two connectors, taking account of the different pin numbering arrangement. In this discussion, the pin out of the memory board and the pin out of the associated motherboard connector (socket) have the conventional one-to-one arrangement, and therefore, when either the memory board or the connector is described, the description should generally be interpreted to refer to both.

The universal memory socket and memory card of FIG. 12, uses the extreme right end pins to accept +12VDC as a single voltage power input. In the JEDEC specifications, each pin is rated at 0.5 amperes of current. At present, pins 1, 114, and 228 are used for +12VDC. As a precaution against miss-mating of the memory module with the connector, the pins adjacent to the power pins were omitted so that, for example, there is an open space of one pin spacing between pins 1 and 2. This may be seen in FIG. 11. From an evolutionary point of view, the omitted pins may be considered as spare pins, such as existing pin locations 60-64. At present the space between pins 59 and 60, and the corresponding space between pins 173 and 174 are used for the DDR2 key slot, but may be allocated to other uses in future.

The designation of the pin outs of the universal memory module is exemplary only, and is based on the use of the memory module in a tree architecture, where the memory module includes a configurable switching element (CSE). A module of this type is being developed by Violin Memory, Inc. Iselin, N.J., and termed a VIMM (Violin Intelligent Memory Module). The memory module is configured for a plurality of differential signaling pairs, and the three input/output ports are designated as AIN, AOUT, BIN, BOUT, CIN and COUT. Each of the differential pairs is designated as P (positive) or N (negative). While these designations may serve to identify functions in an existing design, such designations should not be considered to limit the use of any of the pins of the memory module or connector. Between each pair of signaling lines a power return VSS is positioned. This may be a ground, and may be used to increase the signal isolation between adjacent differential signaling pairs, and provide a low-impedance power return. The traces for VSS may be connected together, routed independently, or be a combination of the two configurations.

In an aspect, selected pins on the memory module may interface with the connector so as to control the application of power to the connector pins. Pins 2 and 113, designated PRES and PRES2 may be used to sense the presence of the memory module in the socket. This may be done by connecting pins 2 and 113 on the memory module so that a connection may be made between the corresponding pins of the connector when a module is plugged into the connector. Alternatively, the pins 2 and 113 may be connected to one or more of the VSS traces on the memory module. When the memory module is plugged into the connector, a ground is provided at pins 2 and 113 when each of the pins has engaged the connector. Waiting to apply power until both pins have engaged the connector ensures that the memory module has been properly seated. Depending on the specific design, this technique of controlling the power is optional.

In an aspect, the memory controller may poll each of the memory modules at system start up and discover the configuration of each of the memory modules. This action establishes the configuration of the memory system and may permit the memory controller to determine the type and quantity of memory in each module, the command set executable by each of the memories, and other attributes such as command timing, bus speed and the like. To the extent that the chip protocol converter has not resulted in the memory being transparent to a command, bus speed and the like, the memory controller may provide the remainder of the adaptation.

The bus type has been described in an example as a high-speed serial bus, but any type of bus suitable for interfacing with a memory may be used. The number of memory modules attached to each bus may be one or a plurality of memory modules, and a plurality of busses may be associated with a single computer or memory controller. Bus types such as multi-drop, stub, ring type, tree type, and the like, may be used, where the bus interface and chip protocol converter are used to effect the universal interface properties. The protocols may be deterministic, or probabilistic such as with Ethernet, and synchronous or asynchronous transmission methods may be used. In an aspect, polling of the modules may be performed using an out-of-band connection

The bus interface has been described in the examples as being located on the memory module; however, a bus interface may be located in whole or in part on a motherboard and associated with one or a plurality of memory modules. Some aspects of the bus interface and chip controller may be located on the memory module and some aspects may be located on the motherboard.

It is therefore intended that the foregoing detailed description be regarded as illustrative rather than limiting, and that it be understood that it is the following claims, including all equivalents, that are intended to define the spirit and scope of this invention.

What is claimed is:

1. A memory system, comprising:
a first circuit card and a second circuit card each card, each circuit card further comprising:
a memory circuit;
a bus interface circuit having a interface compatible with a bus electrical interface and digital protocol;
a memory protocol converter compatible with a memory circuit electrical interface and digital protocol;
a first voltage converter;
wherein an output voltage of the first voltage converter on the first circuit card is different than an output voltage of the first voltage converter on the second circuit card.

2. The memory of claim 1, wherein the first circuit card and the second circuit card have a same connector type.

3. The memory of claim 2, wherein at least the power pins of the connector of the first circuit card and the power pins of the connector of the second circuit card are located at the same position of each card.

4. The memory of claim 3, wherein bus connection pins of the connector of the first circuit card and bus connection pins of the second circuit card are located at the same position of each card.

5. The memory of claim 2, wherein the connector has a key disposed so as to prevent insertion in a standard DIMM socket.

6. The memory of claim 2, wherein the connector has pins disposed at opposite ends of the connector and configured so as to inhibit operation of the power supplies until both a ground and a power connection are made.

7. The memory of claim 1, wherein each circuit card has a configurable switching element (CSE) adapted to provide the interface to bus and to the memory on each respective card.

8. The memory of claim 1, wherein the first circuit card has a first memory type and the second circuit card has a second memory type.

9. The memory of claim 8, wherein the first memory circuit type is DRAM (dynamic random access memory) and the second memory circuit type is FLASH memory.

10. The memory of claim 8, wherein the first memory is a persistent-type memory and the second memory is a non-persistent-type memory.

11. The memory of claim 1, wherein at least one of the first circuit card or the second circuit card has a buffer memory.

12. The memory of claim 1, wherein a signal received on an input port of the bus interface circuit at the first circuit card or the second circuit card controls a future time power status of an output port of the first or second circuit card, respectively.

13. The memory of claim 1, wherein at least one of a time offset or a time duration of the future time status of each circuit card is configurable.

14. The memory of claim 1, wherein a signal received on an input port of the bus interface circuit at the first circuit card or the second circuit card controls a future time status of an electronic component of the first circuit card or the second circuit card, respectively.

15. The memory of claim 1, wherein a signal received on an input port of the bus interface circuit at the first circuit card or the second circuit card controls a future time power status of an input port of the first or second circuit card, respectively.

16. The memory of claim 1, wherein an output voltage of the first voltage converter of the first circuit card and an output voltage of the first voltage converter second circuit card are compatible with a supply voltage requirement of the memory type of the circuit card.

17. The memory of claim 16, wherein the first voltage converter of the first circuit card has a second voltage output having a second voltage value and the second output voltage value is different than the first voltage output value.

18. The memory of claim 16, wherein the input voltage is greater than the output voltage of the voltage converters.

19. The memory of claim 1, wherein the output voltage of the first voltage converter of the first circuit card and the output voltage of the first voltage converter of the second circuit card are each less than half of the input voltage to the first voltage converter.

20. A circuit card, comprising:
a memory circuit;
a bus interface circuit having a interface compatible with a bus electrical interface and command interface protocol;
a memory protocol converter compatible with a memory circuit electrical interface and interface command protocol; and
a first voltage converter,
wherein an output voltage of the voltage converter is less than one half of the input voltage of the voltage converter.

21. The circuit card of claim 20, wherein the memory circuit is at least one of a persistent memory type or a non-persistent memory type.

22. The circuit card of claim 20, wherein a signal received on an input port of the bus interface circuit controls a future time power status of an output port.

23. The circuit card of claim 20, wherein the power status is one of powered on or standby.

24. A memory system, comprising:
a motherboard, further comprising:
a socket adapted to communicate with a pluggable memory module;
a plurality of traces connecting the socket to a memory controller, including at least a power trace;
a memory controller configured to communicate with a memory module pluggable into the socket; and,
a power supply connectable to the power trace;
wherein the memory controller discovers a memory type on the memory module and the bus electrical interface and power supply voltage are independent of the memory type.

25. The memory system of claim 24, wherein the input voltage of the power supply is at least twice a maximum voltage requirement of the memory type.

26. The memory circuit of claim 25, wherein the input voltage is 48 volts.

27. A memory system, comprising:
a first circuit card and a second circuit card each card, each circuit card further comprising:
a memory circuit;
a configurable switching element (CSE) adapted to provide an interface to the memory circuit and to a bus interface circuit;
the CSE further comprising:
a first port and a second port, each port having a plurality of signal lanes and configured to at least one of receive or transmit signals on a bus;
wherein the CSE is configurable to interpret a first signal of the received signals so as to change the state of a signal lane of the plurality of signal lanes at a future time, and route a second signal of the received signals to one of the memory circuit or the second port;
and
a first voltage converter;
wherein an output voltage of the first voltage converter on the first circuit card is different than an output voltage of the first voltage converter on the second circuit card
